(19) United States
(12) Patent Application Publication
(10) Pub. No.: US 2004/0023722 A1
(43) Pub. Date: Feb. 5, 2004

(54) Virtual video stream manager

(75) Inventors: Vinh Thanh Vuong, Simi Valley, CA (US); Son Thanh Vuong, Vancouver (CA)

Correspondence Address: CRAIG E. SHINNERS, LAW OFFICE OF CRAIG E. SHINNERS, 301 E. COLORADO BLVD, SUITE 610, PASADENA, CA, 91101, US

(73) Assignee: VT TECH CORP., Simi Valley, CA (US)

(21) Appl. No.: 10/212,477

(22) Filed: Aug. 3, 2002

(51) Int. Cl. G06F 17/00

(52) U.S. Cl. 463/40

(57) ABSTRACT

The present invention relates to an improved system and method for both local and remote players to play a casino game. More specifically, the system and method automatically transmits a video stream comprised of a plurality of video feeds to remote players showing in an efficient manner. In accordance with the present invention, a virtual video stream manager is associated with a gaming table. By monitoring movement and placement of detectable gaming objects, the virtual video manager determines both the game state and the location of the relevant gaming object. Based on the game state and the location of the gaming object, the virtual video controller selects one of a plurality of video cameras to transmit the video to each of the remote players. The virtual video manager selectively customizes the video transmitted to each remote player so that the remote players may independently and efficiently participate in the remote play of a casino game.

### (1) PRIORITY APPLICATION

This application claims priority under pending Provisional Patent Application Serial No. 06/310,053 filed Aug. 4, 2001 entitled VIRTUAL VIDEO STREAM MANAGER, the disclosure of which is incorporated herein for all purposes.

### (2) RELATED APPLICATIONS

This application relates to the following commonly assigned patent applications, pending U.S. patent application Ser. No. 09/782,833 filed Feb. 14, 2001 entitled SYSTEM AND METHOD FOR DETECTING THE RESULT OF A GAME OF CHANCE, pending U.S. patent application Ser. No. 10/121,621 filed Apr. 11, 2002 entitled SYSTEM AND METHOD FOR LIVE INTERACTIVE REMOTE GAMING USING CASINO-BASED PROXIES, and pending U.S. patent application Ser. No. 10/179,605 filed Jun. 25, 2002 entitled Intelligent Casino Management System and Method for Managing Real-Time Networked Interactive Gaming Systems, the disclosures of which are incorporated herein for all purposes.

### BACKGROUND OF THE INVENTION

1. Field of the Invention

The present invention relates to a system and method for remote interactive gaming and more particularly to a system and method that enables remote players to view the action at a remote live action game of chance from a plurality of perspectives during play of the game.

(4) Playing games of chance over the Internet is a popular past-time for many people. Rather than play against a computer generated game, many players prefer to play at an actual casino where there is a real deck of cards or pair of die by way of a remote real-time interactive gaming system (IGS). One such IGS was described in U.S. Pat. No. 5,762,552, assigned to VT TECH Corp., the assignee of the present invention.

When a remote player selects a gaming table, which may be a gaming table located on the floor of a casino, the IGS transmits broadcast quality video signals to the remote player so that they can monitor play at the table. Based on the video feed, the player may monitor activity at the gaming table and contemplate placing a wager using a virtual bet board for the next to occur play. In this manner, the remote player is provided with the same game just as if they were seated at the gaming table in the casino.

Unfortunately, when the player is remote, the video image of the action at the gaming table is static. That is, a single camera is focused on the table so that the remote player is provided a single panoramic visual image of the table. To better illustrate the problem, if the gaming table is a craps table, a single camera will provide a panoramic view of the craps table. Unfortunately, from this video feed, it is difficult for the remote player to visually determine the value of the dice after the throw. For this reason, a second camera may be focused on the portion of the craps table where the dice will be positioned after the shooter completes the throw. Due to the large expanse of area, a plurality of such cameras may be positioned to cover smaller portions of the craps table. However, it may still be difficult for a remote player to detect the value of the dice. Accordingly, a third camera may be focused on a dedicated area of the table where the croupier places the dice after the throw. Additional cameras may be necessary to provide views of the croupier or other gaming employees.

Thus, in order to provide a plurality of perspectives of the gaming table, the casino must provide a casino employee dedicated to selecting one of the available cameras from which the video stream is provided to remote players. Manual control of the cameras is expensive, repetitive and subject to mistake and error by the casino employee. Clearly, what is needed is an automatic system and method for detecting the appropriate view of the gaming table to be provided to remote players.

### SUMMARY OF THE INVENTION

The present invention relates to a system and method for detecting various stages relating to the play of a game of chance in a casino. More particularly, the present invention relates to an improved system and method for playing a live game of chance and automatically broadcasting one of a plurality of video feeds to remote players in an efficient manner.

The system comprises a gaming table which in the preferred embodiment is an intelligent table adapted for playing a live game of chance, a table manager for interfacing the table to a computer network and a detectable gaming object such as is described in pending U.S. patent application Ser. No. 09/782,833 filed Feb. 14, 2001 entitled SYSTEM AND METHOD FOR DETECTING THE RESULT OF A GAME OF CHANCE, the disclosure of which is incorporated herein for all purposes. Associated with each smart table is a plurality of video cameras (or other broadcast quality cameras) that generate a plurality of video feeds each showing a different perspective of the smart table. By way of illustration, a first set of cameras provides a panoramic view of the table so that remote players can see the entire area of the smart table's playing surface. A second set of cameras provides a close-up view of various selected areas of smart table's playing surface. A third set of cameras provides view of the area surrounding the smart table playing surface so that the remote player may ‘see’ the gaming employee, selected players playing the game or the general casino ambiance. As used herein, the phrase “selected players” refers to players who are playing as a proxy for one or more remote players. Close up views of these selected players are captured by a camera while players standing or seated next to the proxy is not broadcast. Proxy players are more fully described in pending U.S. patent application entitled SYSTEM AND METHOD FOR LIVE INTERACTIVE REMOTE GAMING USING CASINO-BASED PROXIES, Ser. No. 10/121,621 filed Apr. 11, 2002 which claims priority from Ser. No. 60/283,807 filed Apr. 13, 2001, the disclosure of which is incorporated herein for all purposes.

Determining which broadcast feed is to be transmitted to remote players is a daunting task especially as the number of remote players increase. In accordance with the present invention, a virtual video stream manager is associated with the smart table to automatically monitor the play of the game at the smart table and transmit a unique sequence of video images, selected from the plurality of available video feeds generated by the first, second and third sets of cameras, to each remote player.

Advantageously, the virtual video stream manager (VSM) monitors the location of the gaming objects to determine an appropriate video feed to transmit to each remote player. For example, if the game of chance is craps and the die are in the control of the croupier, the VSM selects between a panoramic view of the craps table, a panoramic view of the casino environment and close up views of the gaming employees conducting the game. The selection criterion is determined by a circular menu list. The list determines how the selected sequence will vary for each play. During this phase, both physical players and remote players may place wagers on the next to occur play.

When the gaming object is presented to the shooter, a second menu list is invoked to select a sequence of feeds that are more focused on the portion of the table where the shooter is located followed by a close-up view of the portion of the table where the die are located after the throw. After the throw, the croupier collects and moves the die to a defined area where a close up feed of the die is transmitted to the remote players. Advantageously, as the croupier is collecting the die, the smart table is determining the value of throw and remote wagers are automatically settled. At the same time the VSM is providing the remote players visual confirmation of the result by showing a close-up image of the die that are now positioned in the defined location on the craps table. After an appropriate interval, the VSM returns to a selection of the panoramic views provided by the first set of cameras.

If the game of chance is a card game, such as, by way of example, blackjack, the second set of cameras may comprise a dedicated camera for each playing position while the third set of cameras may provide images of the dealer and each of the players. Clearly, some or all of the players may desire to opt out of having their image transmitted to remote players.

The present invention provides the capability to adapt common casino games, and particularly card games, to live interactive remote play in a manner that is interesting for the player but is inexpensive and reliable for the casino operator. Advantageously, the present invention permits a large number of remote players to independently play a game of chance in a manner that does not affect either the rate of play or the outcome of the game for the other players physically present at the table.

These and other advantages of the present invention are more clearly described in the following detailed description of a preferred embodiment.

### DESCRIPTION OF THE DRAWINGS

FIG. 1 shows a block diagram of one embodiment of an exemplary interactive casino system.

FIG. 2 illustrates a top view of a gaming table.

FIG. 3 is a block diagram of processing logic of the video manager mechanism in accordance with the present invention.

FIG. 4 shows the panoramic view footprint of a first set of cameras associated with the smart table of FIG. 2.

FIG. 5 shows the view footprint of a second set of cameras associated with the smart table of FIG. 2.

FIG. 6 shows the view footprint of a third set of cameras associated with the casino environment.

FIG. 7 is a block diagram of a gaming table in the casino environment.

FIG. 8 is an operational flow diagram of the operation of the virtual video manager.

FIG. 9 illustrates the interconnection of the casino environment with a plurality of remote kiosks in a plurality of jurisdictions.

### DETAILED DESCRIPTION OF A PREFERRED EMBODIMENT

The present invention relates to a system for enabling remote play of a live action game of chance. More particularly, the present invention relates to an improved gaming table having a plurality of gaming objects and a method that enables an unlimited number of players to participate in a live action game of chance. In the following description of the preferred embodiment, reference is made to the accompanying drawings that form a part hereof, and in which is shown by way of illustration a specific embodiment in which the invention may be practiced. It is to be understood that other embodiments may be utilized and that changes may be made without departing from the scope of the present invention. Reference will now be made in detail to the preferred embodiments of the invention, examples of which are illustrated in the accompanying drawings.

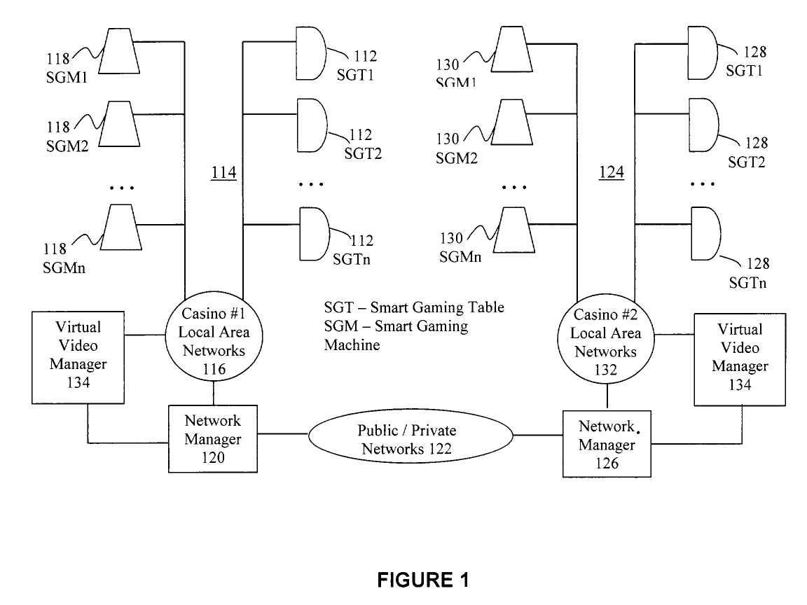

FIG. 1 illustrates the hardware components of an exemplary interactive casino system 110 for practicing the invention. Specifically, system 110 comprises a plurality of smart gaming tables 112 at a first casino 114. At each table, a sequence of plays of a particular game of chance is conducted. By way of example, one table may be a blackjack table, another table a roulette table and yet another table is a craps table. It will be apparent to one skilled in the art of casino management that gaming table 112 may be any regulated casino game or slot machine.

Each gaming table 112 is connected to a local area network 116. A plurality of gaming machines 118 is also connected to network 116. By selecting one of said plurality of gaming tables 112, a remote player (not shown) positioned at one of the gaming machines 118 can participate in the play of the game of chance conducted at the selected table.

Casino 114 also includes a network manager 120, which is connected to network 116. Network manager acts as a portal to a public or private network 122, which may be a telephone, satellite or Internet network or any other worldwide communication network. A second casino 124 is also coupled to network 122 via network manager 126. Casino 124 is essentially a mirror image of casino 114 in that it comprises a plurality of gaming tables 128 and gaming machines 130 each and which are coupled by a local area network 132 to network manager 126. Gaming machines 130 are identical to gaming machines 118 except that they are located at a site remote from casino 114. Similarly, gaming tables 128 are identical to gaming tables 112 except that they too are located at a different site. This configuration is disclosed in U.S. Pat. No. 5,762,552 which issued Jun. 9, 1998, assigned to VT TECH Corp. the assignee of the present invention, the disclosure of which is incorporated herein for all purposes.

However, in accordance with the present invention, system 110 is improved by including “smart” gaming tables that enhance the speed and reliability of play of a wide range of games of chance. More specifically, each smart gaming table includes detectable objects that enable the automatic detection of the result of each play of the game. By way of example, if the game is a card game, the smart object comprises playing cards that include a radio frequency transmitter that is detectable when in the proximity of a detector circuit. The smart table includes a plurality of detector circuits to track and monitor the play of the game. Again, by way of example, each playing position and the shoe comprise a detector circuit associated therewith. As cards are dealt from the shoe, the system is able to detect not only the value of the card but also the position on the table where the card is placed.

A virtual video manager 134 is coupled to network managers 120 and 126. Virtual video managers 134 are also coupled to gaming tables 112 and 128 by networks 116 and 132, respectively. Virtual video managers 134 are responsible for selecting from a plurality of video streams to be transmitted to gaming machines 118 and 130 over networks 116 and 132, respectively, and to other remote players over network 122.

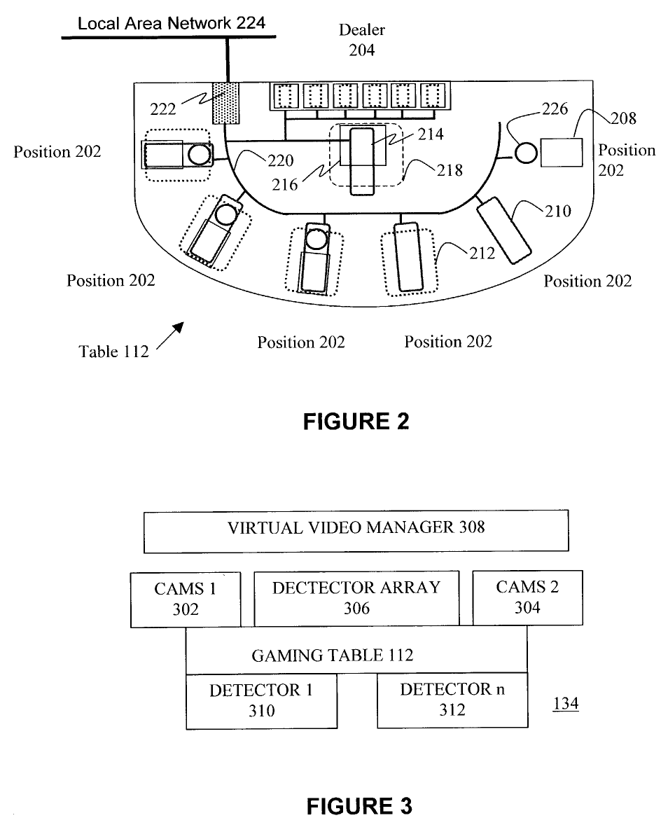

Referring now to FIG. 2, a top view of a gaming table 112 is illustrated. Table 112 comprises a flat playing surface covered with felt on which is typically printed a bet board for a particular game. The printed felt could delineate where the cards are dealt and where the bets are positioned. Typically there are a total of six playing positions 202 if the table is used for blackjack or pai gow poker and a dealer position 204. Other card games may have more or fewer playing positions printed on the felt or may omit the dealer's position. Associated with each playing position 202 is a bet slot 206 where a player may place a bet for the next to occur game of chance. Also associated is a defined position 208 where the cards are dealt.

At least one reader 210 is coupled to gaming table 112 and closely proximate to at least one of the playing positions 202. In the illustrated embodiment, each playing position 202 is provided with a detector 210 although it has been eliminated from one position in FIG. 2 to clearly illustrate additional features of each position 202. One skilled in the art will appreciate that each table may have any number of positions 202 and is not limited to merely the six positions 202 that are illustrated. Each detector 210 is configured to have a relatively detection short range as indicated by the dashed lines 212 surrounding each player position 202. Again, the range indicator has been omitted from two positions to clearly illustrate the reader and other features at these positions.

Gaming table 112 also includes a detector 214 positioned proximate to the dealer position 204 and more particularly proximate to the defined position 216 where the dealer's cards are initially positioned. As with detectors 210, detector 214 is configured with a relatively short range, as indicated by dashed lines 218 so that there is no overlap in detection field with the other detectors. Each gaming table 112 includes a detector network 220 that terminates at a table manager 222. Table manager 222 is responsible for coupling network 220 to a local area network (LAN) 224. Table manager 222 is the local manager that links and manages access to the network manager 120 (FIG. 1) via LAN 224. Detectors 210 and 214 comprise, in a preferred embodiment, a proximity detector capable of reading the value of one or more gaming objects positioned within the detection range.

FIG. 3 is a hierarchical block diagram of the video manager mechanism 134. In a preferred embodiment, there is a first plurality of cameras 302, a second plurality of cameras 304 and a detector array 306 associated with each gaming table 112. Each of the plurality of cameras is dedicated to covering a specific region of the gaming table 112 and selected regions of the casino floor.

Cameras 302 and 304 and detector array 306 are coupled to a virtual video manager 308. Each of the cameras generates a video stream that is selected by virtual video manager 308 in response to the detected game state. In essence, virtual video manager 308 acts as a video multiplexor where the selection sent to the remote player is choreographed with the actual play of the casino game at the selected table. Further, each camera has a different zoom, tilt and subtends different portions of the gaming table. Virtual video manager 308 then selects one video stream to transmit to each remote player based on the state of play of the game and the location of the gaming object.

A significant challenge in providing an entertaining remote viewing of the live action game of chance is to select a camera view for each remote player that is not only linked to the play of the game but that varies from play to play. This link is provided by detector array 306, which monitors play at gaming table 112 and provides virtual video manager 308 with an understanding of the whether the game state is at the beginning of play, in the middle of play or completed. Based on this information, virtual video manager selects either a broad panoramic view of gaming table 112, a view of a portion of gaming table 112 or one of a plurality of close up view of the gaming table showing the result for each remote player.

Detector array 306 is coupled to a plurality of detectors, such as reader 310 and 312. Readers 310 and 312 are coupled to gaming table 112, typically positioned under the felt so as not to be visible to the players at the table. In general, readers operate to detect the motion of each gaming object through or at a specific region of the gaming table.

To illustrate, in the game of baccarat, a local player, that is a player physically present at the table, is provided the opportunity to “open” the player's hand. Thus, after wagers are placed, the player's hand comprising two cards are passed to the local player. Motion of the cards, also referred to as smart objects, are detected by reader 310 if the cards are passed to one end of the table and detected by reader 312 if passed to the other end of the table. For other games, such as blackjack or pai gow, additional detectors, such as readers 210, are used to detect the position where the cards are located. Using information the detector array obtains from gaming table 112, virtual video manager 308 is able to deduce the stage of play of each game and select the camera that provides the best view for each of the remote players.

The general location of the action is based on the use of a detectable gaming object having a radio frequency proximity circuit embedded therein. Movement of the detectable object is detected by detector array 306. By way of example, object may be either passive such as a reflector or active, such as a light emitting diode or radio frequency signals such that as gaming object is moved across the field of view of detector array 306, movement and direction of movement is detected. Thus, when a croupier positions a gaming object in the region surrounding the starting position, detector array tracks the movement of the gaming object.

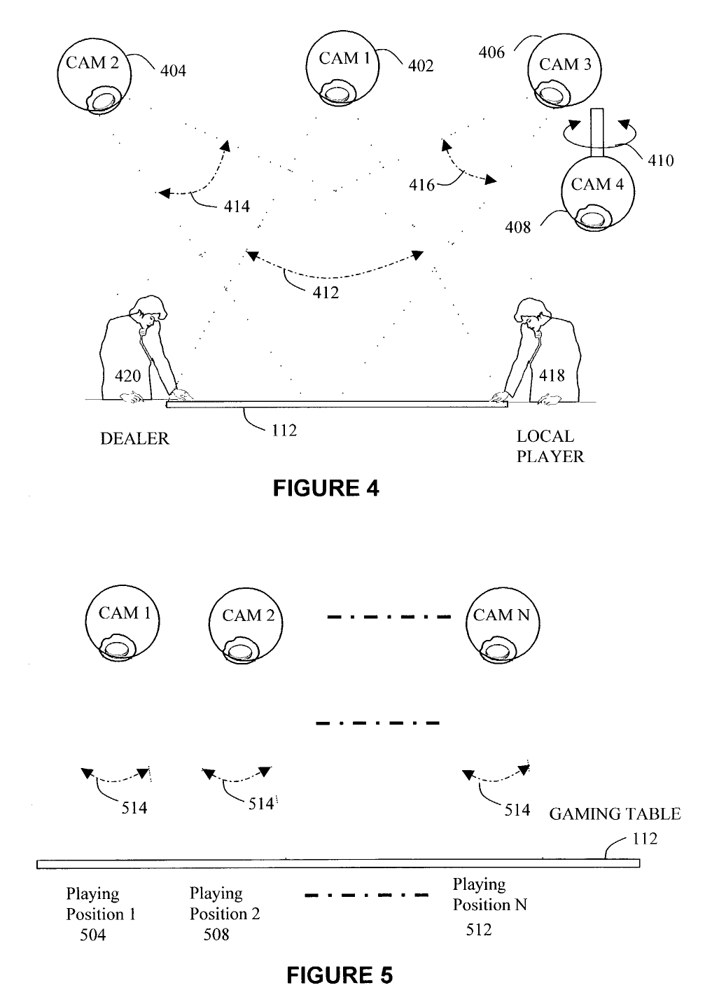

FIG. 4 illustrates a first set of cameras associated with a gaming table. It will be apparent that gaming table may comprise any casino game such as craps, blackjack, poker, baccarat, or other casino card games or roulette. In other embodiments, a slot machine or a remote kiosk may replace the gaming table. The first set of cameras comprises camera 402, 404, 406 and 408 that are positioned to obtain selected views of gaming table 112. Although only four cameras are shown in FIG. 4, it will be apparent that more or fewer cameras may be included in the first set.

In the illustrated embodiment, camera 402 has a wide, top down field of view, as indicted by dashed line 412, that subtends the entire playing surface of the gaming table 112. Cameras 404 and 406 provide a field of view, as indicated at 414 and 416, that subtend at least a portion of the gaming table as well as one or more players 418 or the dealer 420. The lens angle of cameras 404 and 406 is slightly oblique. As illustrated, camera 404 targets the right side of the gaming table 112 and player 418. Similarly, camera 406 has a field of view that includes the dealer or casino employee 420. Cameras 402-406 are selected by the virtual video manager 134 during the initial state of play of the game to provide the remote player with a wide panoramic view of the gaming table.

While cameras 402-406, are typically mounted in a static orientation, camera 408 is mounted on a rotating gimbaled mount so that it may positioned to obtain a plurality of views of the casino environment, as indicated by dashed line 410. Camera 408 slowly rotates to provide visual perspectives of the casino zone in a manner that gives an overview of the activity and other tables. This video stream may be broadcast to remote players between plays of the game to convey images of the crowd at other tables. Thus, while the players are placing wagers for the next to occur play, virtual video manager 308 selects from among a table view (camera 402), to a right table view (camera 404) to a panoramic view of the casino (camera 408) followed by a view of the left side of the table. During the next wager period, virtual video manager alters the sequence of views in a pseudo random manner to provide a unique video feed to remote players.

It will be apparent to one familiar with the size of the typical gaming table that the field of view associated with cameras 402-406 must be sufficiently large to encompass the entire table. Because of the large field of view, it will be difficult for a remote player to easily detect the results of a play of the game especially if the gaming object is a small die or a playing card. Accordingly, a second set of cameras is provided, as illustrated in FIG. 5, which has a very narrow field of view. Specifically, each camera in the second set is targeted, or focused, on a position on the table where the gaming object or objects are to be positioned. By way of example, if the gaming object is a playing card, camera 502 is tightly focused on a corresponding playing position 504. The field of view 514 and the zoom of camera provide a close up view of the gaming objects so that it may be readily detectable by the remote player. Cameras 506 and 508 are similarly focused on corresponding playing positions 508 and 512, respectively. If the game is a game such as craps or baccarat, the gaming object is positioned in a single playing position. Accordingly, the third set of cameras must include at least one camera but may include additional cameras to provide a variety of angles.

It should also be understood that that each camera in the first, second or third camera sets may include a zoom feature so that the camera may zoom in on a targeted area under control of the virtual video manager.

For games such as baccarat or craps, the number of cameras in the second set may be limited to one or two cameras because there is no need to provide a close-up view of each playing position. For example, in craps, it is only necessary to determine that the shooter is on the left side of the table (camera 404, FIG. 4) and that the dice will be most likely on the left side of the table (camera 406). Then, once the croupier collects the dice and positions them in a viewing area, a camera in the second set of cameras, such as camera 502, provides the tightly focused, narrowed field of view for the remote players to visually confirm the audio announcement of the winning number.

Similarly, in baccarat, if a player is opening a hand on the right side of the table, the wide-angle view of camera 404 or, alternatively camera 402, are selected as the video feed for the remote players. Detection of the direction of movement of the gaming object is facilitated by the use of detectors 310 and 312 because each detector includes a plurality of antennas for detecting the passage of the gaming objects through one of a plurality of previously defined regions. Thus, detector 310 is able to differentiate the region where the card is passed so that the virtual video manager 308 can select the best camera view for the remote player as the local player is opening the cards.

When the local player passes the cards back to the dealer, the detector again provides the information to virtual video manager 308, which then selects a camera that provides a tightly focused view on the relatively small region of the table where the dealer places the cards to compare the player's hand to the bank's hand.

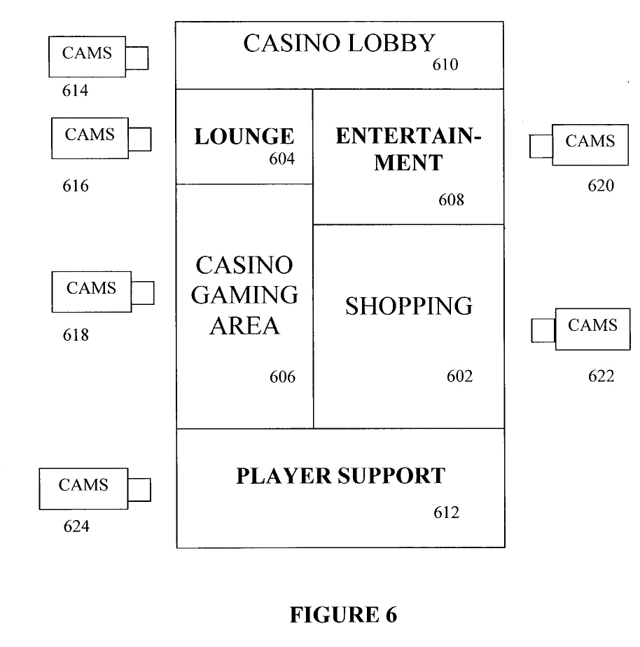

FIG. 6 is a block diagram that illustrates a footprint of a third set of cameras. Specifically, once the remote player decides to terminate play at a gaming table, the remote player may select a proxy player equipped with a portable camera strolling through the casino, playing at a slot machine or at a kiosk.

In one embodiment, the casino environment is organized in a plurality of zones with each zone having either sets of cameras mounted therein or a set of wireless receivers (not shown) for receiving the video feed generated by a video camera carried by the proxy player. The casino environment 600 includes a plurality of zones such as the casino lobby 602, a lounge 604 where players may relax in quiet comfort, an entertainment venue 608 where bands, comedians and the like perform from time to time, the casino gaming area where either gaming tables and gaming machines are located, a shopping 610 zone having food and other shopping venues and a player registration and support 612 zone.

Associated with each zone is a set of cameras or wireless video receivers as indicated by camera sets 614-624. Thus, as a proxy player strolls through a casino, the remote players can tag along by receiving a real time video stream from the camera sets activated by the proxy player. Alternatively, by interleaving this video stream with a video stream from one or more gaming tables, the remote player may customize the video displayed on their remote gaming machine.

Because of the privacy rights of casino patrons, casino environment 600 is separate from the public casino. Thus, both the employees and the patrons will consent to having their voice and likeness broadcast to remote players before entering casino environment 600. In essence, casino environment 600 comprises a large sound stage capable of supporting a reality-like programming from a plurality of areas such as the above-described zones. Because of the relatively small size of casino environment 600, it is possible to change the background to suite a variety of themes. Thus, the casino may appear to be a beach-front casino in the winter months while in other months it may be configured to appear as a Brazilian city during Mardi Gras. Other such theme will be readily apparent to one familiar with popular entertainment and vacation destinations.

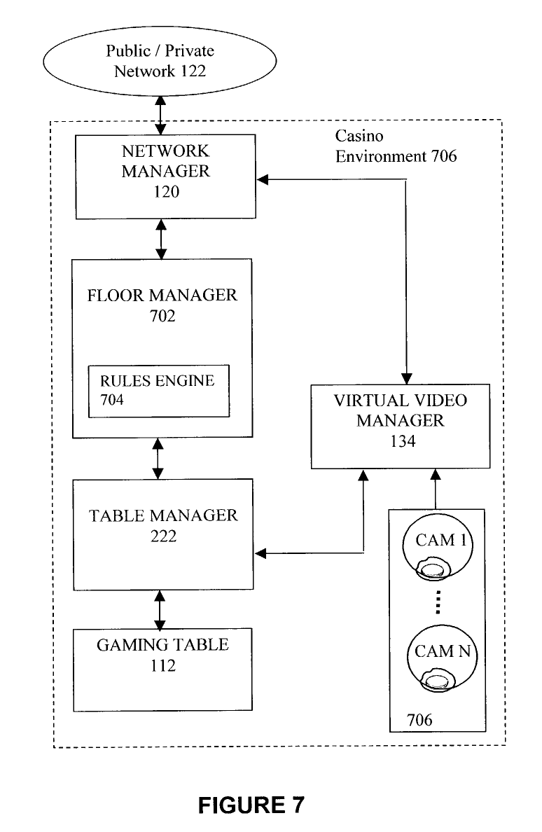

FIG. 7 is an illustration of another embodiment of an interactive casino system in accordance with the present invention. Network manager 120 provides a public portal through which players are provided access to casino environment 600 over a public or private communication network 122, which may be the Internet, public telephone network, a local area network (LAN) or a wide area network (WAN). A player, remote from casino environment 600, may access the casino over network 122 with a telephone, such as a web-enabled cell phone, computer or some other computer-based communication device (not shown).

Network manager 120 is responsible for maintaining the exchange of information between the remote players and the casino environment 600. Specifically, a remote player may connect to casino environment 600. When a game table is selected, network manager 120 establishes an active session for the remote player. Establishing the session includes validating the identity of the remote player, updating the player's database entries so that comps and other promotional benefits can be credited to the player, validating the player's rules engine and whether the player wishes to play on their own or with a proxy.

Once the session is established, network manager 120 links the remote player to a floor manager 702. The floor manager is responsible for handling the player interface with the gaming table. Floor manager 702 includes a rules engine 704 that is specifically customized for each remote player.

Floor manager 702 is linked to a table manager 222 associated with the selected table game. Table manager 222 is responsible for detecting the beginning of play for each game. Table manager 222 also detects where gaming objects are located on the table and passes this information to virtual video manager 134. It will be appreciated that there may be a mix of both local and remote players playing at any given table as well as a plurality of proxy players. Accordingly, table manager 222 recognizes if a player is local or remote and, if remote, whether playing by way of a proxy. A proxy play is a concept that relates to the use of a local player to play a casino game and to allow remote players the opportunity to place a wager beside the local player's wager. Thus, the local player makes any intermediate decisions required in the game while all remote players merely observe the play.

If an intermediate result is required from a remote player, table manager 222 passes the intermediate result to the floor manager 702 and waits for instructions from the remote player or alternatively from the rules engine. Once the play of the game is complete, table manager 222 passes the result for each remote player to floor manager 702 together with an accounting for each wager made by each remote player. To track the plurality of wagers, table manager 222 maintains a list log for each player, whether local or remote, and the respective wagers.

Virtual video manager 134 is coupled between network manager 120 and table controller 222 in parallel with floor manager 702. Virtual video manager 134 receives information from network manager 120 whenever a remote player establishes a session or changes the selected game. Based on the selected game, virtual video manager 134 associates a set of cameras 706 with the remote player. In response to changes in the game state, virtual video manager 134 selects one of the video cameras as the source of video to be streamed to the remote player. Thus, based on the play of the game at the selected table, the appropriate video streams are automatically made available to the remote player.

While the table manager is responsible for monitoring the actual play of the remote player at the gaming table, virtual video manager 134 is responsible for determining how best to provide a video representation of the action at the gaming table for remote player. As video streams are selected, the selected stream is provided to network manager 120 for transmission to each remote player over network 122.

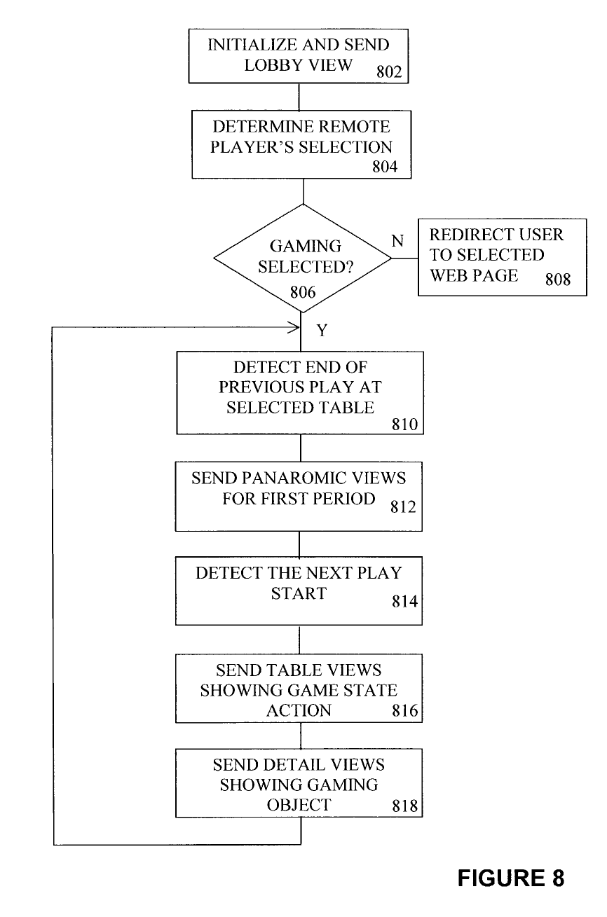

Referring now to FIG. 8, a flow diagram of the virtual video manager is shown. When a remote player accesses the casino from a gaming machine the network manager initiates operation by sending a video stream comprising video from camera set 614 as indicated at step 802. The remote player is provided a selection of activities with each activity corresponding to one of zones 602-612 as indicated at step 804. Once the remote player selects a zone, as indicated at step 806, the remote player's gaming machine is provided with an appropriate video stream from that zone. More specifically, if the remote player selects the gaming zone, flow proceeds to the casino gaming area 606. If the remote player selects a non-gaming zone, the player is directed to a web page corresponding to the selected zone as indicated at step 808. From this web page, the remote player may shop on-line in shopping zone 610, enjoy a broadcast from the entertainment zone 608 or simply ‘wander’ through the casino environment 600 by sampling from a plurality of video steams generated by camera sets 614-624.

Once the remote player selects the gaming zone, flow proceeds from step 806 to step 810. In step 810, the network manager determines which casino game the remote player wishes to play, whether the remote player wishes to associate with a proxy player or to play remotely. After the end of the current play, the network manager begins streaming video from the selected gaming table and solicits the desired wager from the remote player. The virtual video manager 134 determines the video feed provided to the remote player.

As indicated at step 812, virtual video manager 134 selects wide-angle views from the first set of cameras associated with the selected table for the period of time during which wagers are being place. This view provides the remote player a panoramic view of the table so that it is possible to see how many local players are at the table as well as how fast the local players are placing their wagers. Using this information, the remote player is better able to adjust the rate of their play to match the rate of the other players.

When the next play of the game of chance begins, as indicated at step 814, virtual video manager 134 selects a video stream from the second camera set associated with the selected gaming table and provides the selected video stream to the network manager for transmission to the remote player. The table game detects the start of the game when the initial card is dealt, by way of example. Once detected, the virtual video manager 134 interrogates the detectors associated with the table.

Selected cameras in the first camera set provide an intermediate view of the gaming table so that the remote player can observe the portion of the table where the action is occurring. For example, if cards are being dealt from the right side of the table and placed on the left side, the virtual video manager 134 tracks the cards as they are removed from the shoe or the shuffling machine to the other side of the table. While the cards are being dealt, virtual video manager 134 selects the appropriate camera or cameras to provide a close up view of the action for the remote player. During this time-period, virtual video manager 134 may also interleave video feeds from the camera that encompasses the entire table or cameras that include the face of the local players and dealers.

After the dealing is complete and all intermediate decisions have been made, an indication is obtained from the readers and provided to virtual video manager by the table controller associated with the gaming table. At this time, virtual video manager selected from a second set of cameras to provide a close up view of the gaming objects to visually convey the results of the play of the game as indicated at step 818. It will be apparent, that for a card game where each player is dealt a hand, the virtual video manager 134 selects a close-up view of the regions of the gaming table where table felt has a printed zone where the cards are to be positioned. In other games, such as baccarat or craps, all remote players are provided a common video stream showing the gaming object so that all players can confirm the result of the play by viewing the gaming objects.

Thereafter, the management flow returns to step 810 to begin streaming the panoramic views of the gaming table. At this time, the virtual video manager 134 may also stream video from the third set of cameras dispersed throughout the casino environment 600.

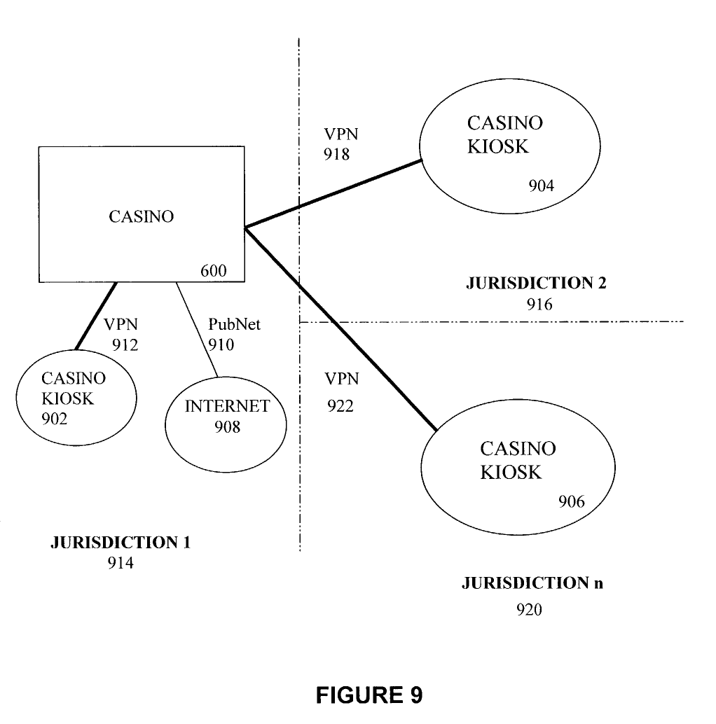

Refer now to FIG. 9 where casino environment 600 is shown connected to a plurality of casino kiosks 902, 904 and 906. Casino kiosks are remote locations where the casino establishes a lounge or other area that is under the control of a casino employee. Thus, minors are prohibited from accessing the casino kiosk. Casino kiosks are set up in locations where it is inefficient to build a brick and mortar casino. Depending on local governmental regulations, casino environment 600 may provide Internet connections 908 from worldwide locations over public network 910. Alternatively, access to casino environment can be limited to kiosks 902 located in the same jurisdiction, that is jurisdiction 904, and linked to casino environment 600 by a virtual private network 912.

Where a regulated casino has brick and mortar casinos in multiple jurisdictions, such as in jurisdiction 914 and jurisdiction 916, kiosks 904 are placed in settings outside of the casino in jurisdiction 916 and linked to casino environment 600 by a virtual private network 918. Similarly, casino environment can be coupled to kiosk 906 which may be located in non-traditional jurisdictions, such as jurisdiction 920. By way of example, a racetrack in the Commonwealth of Kentucky could be linked to a casino in the state of Nevada by a virtual private network 922. In this manner, the racetrack can offer casino games to its patrons and share in the tax revenue generated by their play without having to expend the funds to build a brick and mortar casino.

Operation of an Interactive Casino

The above description of a interactive casino providing gaming opportunities to both local and remote players further includes the The casino environment 600 has two entrances. One entrance is a physical portal through which players (that is, real “local” people) enter to play at the casino environment. The other entrance is a virtual portal through which remote players enter to play in the casino environment.

Local players are either paid entertainers, referred to hereafter as entertainer-local players or “ELPs”, or individual players, referred to hereafter as local independent players or “LIPs.” ELPs are affiliated with the casino manager while LIPs are unaffiliated.

The casino manager provides a realistic ambiance by retaining ELPs and encouraging LIPs to play at the IC. ELPs are similar to cast members at a theme park or resort who are paid to interact with the guests. LIPs, on the other hand, may be charged an entrance fee and provide the important function of increasing the number of players at the casino environment 600 without cost to the casino manager.

ELPs are each provided a set dollar amount on a daily basis with which they may participate at any casino game. ELPs are each equipped with wireless cameras and microphones so that as they stroll through the casino, the shops and shows, the experience is captured on video. These walking, talking, camera-toting ELPs provide a supply of proxy players for the casino environment 600 and generate the ambiance generally associated with a physical “brick and mortar” casino.

The casino retains the ELPs specifically to have their voices and likenesses available for transmission to remote players. Accordingly, the casino manager enters into a contractual relationship with each of the ELPs that specifies that each of the ELPs will forfeit their winnings, if any, when playing as an entertainer. Conversely, ELPs are not liable to the casino manager for any losses that they may incur when playing as an entertainer.

LIPs are optionally equipped with wireless microphones and cameras or they may simply be granted access to the casino environment 600 without being so equipped. LIPs play for their own account using their own money. LIPs must also enter into a contractual agreement with the casino manager because it is likely that their voice and image will be broadcast to remote players. Some LIPs may elect to grant the casino the right to act as a proxy player. Importantly, LIPs are responsible for any losses that they incur when playing a casino game. Conversely, LIPs may retain any winnings from playing the casino games.

Both LIPs and ELPs are eligible for compensation based on selected factors. For example, if one of the LIPs and ELPs is playing as a proxy for a high roller, the remote player generates credits for the LIP or ELP for each hour of play. Thus, while LIPs and ELPs may be losing at a particular game but the hourly credit may be substantial because a large number of remote viewers have selected the LIP or ELP as their proxy. Allocating credits to the LIPs and ELPs is a key motivational incentive for each LIP and ELP to create an exciting and interesting environment that attracts remote players.

The casino environment 600 is preferably based on a theme. For example, one virtual casino environment 600 may be based on an elegant European casino with all casino employees in formal attire and the ELPs and LIPs conforming to a dress code requiring a coat and tie for males and dresses for the women players. Thus, the video stream provided to the remote player will provide the impression of a high-class casino environment.

Another virtual casino environment 600 may be based on a casual Caribbean theme with casino employees casually dressed and the ELPs and LIPs encouraged to wear swimwear or resort-wear. It should be apparent to one skilled in the art, that a variety of such themes are readily implemented and the examples provided herein are in no way intended to be limited to the described embodiments. To further the impression provided to the remote player, the casino may rent costumes to the LIPs so that they too may comply with the dress code for a particular theme. Examples where costumes rentals may be appropriate would be if the casino theme were based on a time-period where typical period-specific attire is no longer commonly available to most LIPs (i.e., the dress code requires a Victorian or Renaissance time period costume).

For remote players, the entrance to the casino environment 600 is through virtual portal accessed over the Internet or other similar communication network using a common browser or other means for establishing a communication link. By way of example, a remote player may use a browser, such as Internet Explorer provided by Microsoft Corporation, Redmond Wash., to access a web page maintained by the casino managers on the world wide web. Accessing web pages in this manner is well understood and the manner in which the communication link is established is not critical to the present invention.

To contend with legal issues, remote players play from a remotely location that is a controlled environment in one preferred embodiment. A controlled environment is a location such as a coffee shop, bar or tavern located in a jurisdiction where remote gaming is permitted by applicable laws and regulations.

An attendant is responsible for screening for minors and preventing them from playing and for providing refreshments for the remote players. To provide a comfortable environment, the casino may comp the remote player's drink or meal depending on the average amount wagered and the length of time played. The concept of maintaining a historical log file of the wagers made by a player and for determining whether comps are appropriate is described in pending U.S. patent application Ser. No. ______ filed Jun. 28, 2002 (based on Provisional Patent Application Serial No. 60/301,939 filed Jun. 29, 2001) entitled Intelligent Casino Management System and Method for Managing Real-Time Networked Interactive Gaming Systems. This application is assigned to the assignee of the present application and the disclosure of which is incorporated herein for all purposes.

When a remote player “enters” the virtual casino, they must register and agree to the contractual terms presented by the casino manager. The contractual terms will explain the rules of play unique to remote play and will require the remote player's consent before access to the casino environment 600 is provided. Preferably, the remote player provides an electronic signature as provided for in the Electronic Signatures Global and National Commerce Act (E-SIGN) (Pub L 106-209, to be codified at 15 USC §§7001 et seq.). The electronic signature authenticates the necessary ‘written’ agreement to pay all debts incurred at the casino environment 600, to authorize distribution of their image and their voice, and to acknowledge that the player will abide by the casino's on-line rules.

The remote player is also requested to select a “default” manner of play. The defaults are saved for each player. Thus, if the communication link to the casino environment 600 is disrupted, if the remote player leaves before the completion of a game or if the remote player is simply non-responsive, a rules engine will take over and complete the play for the remote player in a manner determined by the player selected defaults.

After the formalities of establishing the remote player's account are completed, the remote player is presented with a choice. The remote player may select an avatar, a LIP or an ELP to act as their guide through casino environment 600 or the player may go directly to a selected game within the IC.

Using the avatar, the remote player may navigate through the casino environment 600 and view a graphical representation of casino environment 600 of the casinos. The avatar may stop at gaming tables selected by the remote player and provide the opportunity for the remote player to view streaming video of the casino environment. In such instances, the graphical representation is replaced by streaming video, if available, and the remote player may see the ELPs and the LIPs present at the gaming table.

If the remote player selects an ELP or a LIP to act as a guide through the IC, the remote player is provided streaming video from the selected ELP and LIP as well as streaming video of the environment proximate to the selected ELP or LIP. The ELPs and LIPs are responsible for providing entertaining and interesting dialog and visual images to be transmitted to the remote player.

The remote player may elect to use the ELP and the LIP as a proxy for placing wagers. Alternatively, the remote player may play in an independent manner at the same gaming table as the selected ELP or LIP. If the selected ELP or LIP decides to leave the game, the remote player must decide whether to leave with the ELP and the LIP or stay at the game. The remote player may designate an ELP or LIP remaining at the game as the proxy with the authority to place a series of wagers while the remote player “tags along” with the selected ELP or LIP as they stroll through the casino environment.

If the remote player desires to simply play a game independent of an ELP or a LIP, the network manager (FIG. 7) routes the remote player's wagers to the appropriate table and streams video as selected by the virtual video manager from the selected gaming table.

With a large number of LIPs and ELPs having a wireless camera, the protocol involved is rather complicated. Accordingly, a peer-to-peer video system would be desirable due to scalable number of players.

While certain exemplary preferred embodiments have been described and shown in the accompanying drawings, it is to be understood that such embodiments are merely illustrative of and not restrictive on the broad invention. Further, it is to be understood that this invention shall not be limited to the specific construction and arrangements shown and described since various modifications or changes may occur to those of ordinary skill in the art without departing from the spirit and scope of the invention as claimed.

We claim:

1. An interactive casino having a plurality of casino games adapted for play by both local players and remote players comprising:
A gaming table adapted for playing a casino game, said gaming table including at least one gaming object capable of generating an indication of at least one state of play of said casino game and a location indication of where said gaming object is located on said gaming table;
A detector for detecting said indication to state of play of said gaming game and for detecting the said location indication;
A first plurality of cameras, associated with said gaming table, each of which has said gaming table at least partially in its field of view;
A virtual video manager, associated with said gaming table, adapted for selecting a video stream generated by one of said first plurality of cameras in response to detection by said detector of a specific state of play; and
A network manager, associated with said gaming table, adapted for linking said remote players to said gaming table and for transmitting said video stream selected by said video manager so that each remote player is provided an indication of the value of the gaming object and a unique video stream.

2. The system of claim 1 wherein said virtual video manager further comprises means for selecting one of said first plurality of cameras in response to said location indication whereby said selected camera has a field of view that encompasses a portion of said gaming table where said gaming object is positioned.

3. The system of claim 1 wherein said virtual video manager selects a psuedo -random sequence of said first set of cameras.

4. The system of claim 1 further comprising a second set of cameras each of which is focused to provide a video stream of a selected portion of said gaming table to provide a video stream of a full screen image of said at least one gaming object when selected by said virtual video manager.

5. The system of claim 4 further comprising a third set of cameras wherein said virtual video manager selects a psuedo-random sequence of video streams generated by said third set of cameras, said virtual video manager selecting said third set of cameras when said state of play indication indicates that the play of the casino game is complete.

6. A system for a casino card game adapted for play by both local players and remote players at a gaming table; said gaming table having means for detecting the location of cards during the play of said casino card game.
A plurality of video cameras, each having a lens angle subtending at least a portion of said gaming table;
Means for selecting one of said video cameras in response to a detected state of play and a detected location of said cards; and
A network manager for transferring a video stream generated by said selected video camera to at least one remote player.

7. The system of claim 6 further comprising at least one camera having a field of view that does not include said gaming table where said selecting means selects said at least one camera after the completion of said play of said casino card game.

8. The system of claim 6 further comprising:
a second plurality of cameras;
a plurality of wireless video receivers each covering a unique zone of a casino;
a wireless camera coupled to one of said video receivers, said wireless camera transported by a player;
means for selecting either one of said second plurality of video cameras or one of said wireless video receivers when said wireless video receiver is receiving a video stream from said wireless camera.

9. The system of claim 8 wherein said selecting means selects either one of said second plurality of video cameras or one of said wireless video receivers, when said wireless video receiver is receiving a video stream from said wireless camera, in response to a request from said remote player.

10. The system of claim 9 wherein at least one of said local players has a wearable wireless camera.

11. The system of claim 6 wherein said plurality of video cameras includes at least one camera having a lens angle subtending substantially all of said gaming table.

12. The system of claim 11 wherein said plurality of video cameras further includes at least one camera having a lens angle subtending approximately half of said gaming table.

13. The system of claim 12 wherein said plurality of video cameras further includes at least one camera having a field of view sufficient to visually identify the value of each card positioned within the field of view.

14. A method for providing a video stream to a remote player so that said remote player may participate in the play of a casino game at a gaming table located in a casino; said method comprising the steps of:
Initiating a play of a casino game;
Transmitting a video stream to said remote player a video stream from a first camera, said video stream subtending substantially all of said gaming table;
Detecting an intermediate state in the play of said casino game;
Automatically terminating the transmission from said first camera and initiating transmission to said remote player a video stream from a second camera having a field of view comprising the a portion of said gaming table in response to said detecting step;
Detecting the conclusion of play of said casino game;
Automatically terminating the transmission from said first camera and initiating transmission to said remote player a video stream from a third camera displaying the result of the play of said casino game.

15. The method of claim 14 further including the steps of selecting said first camera from a first plurality of cameras.

16. The method of claim 14 further including the steps of selecting said second camera from a second plurality of cameras.

17. The method of claim 14 further including the steps of selecting said third camera from a third plurality of cameras.

18. The method of claim 14 further including the step of:
Upon detection of the conclusion, automatically transmitting a video stream to said remote player from a fourth camera, said fourth camera displaying a portion of said casino other than said gaming table.

19. The method of claim 18 further including the step of selecting said fourth camera from a fourth plurality of cameras.

20. The method of claim 19 wherein said selecting step is in response to a selection by said remote player.

21. An interactive casino where both local players and remote players may participate in the play of a casino game, said casino comprising:
A plurality of zones, each zone having a plurality of video cameras;
A radio frequency detector circuit, carried by one of said local players;
Means for determining the zone where said one of said local players is located;
Means for selecting one of said plurality of cameras in the zone where said local player is located; and
A network manager for transmitting the video from said selected camera to said remote player.

22. The system of claim 21 wherein said local players are attired in accordance with a selected theme.

23. The system of claim 21 wherein each of said remote players may selectively associate with one of said local players; said selecting means adapted to transmit to said remote player video from a camera having said selected local player in the field of view.

24. The system of claim 23 wherein said selecting means determines when to select a different camera to transmit video to said remote player.

25. The system of claim 23 wherein said selecting means determines when to select a different camera to transmit video to said remote player in response to the state of play at a gaming table when said local player is playing at said gaming table.

26. An interactive casino where both local players and remote players may participate in the play of a casino game at a gaming table; said gaming table having means for detecting the location of gaming objects during the play of said casino game, said interactive casino comprising:
A plurality of video cameras, each having a lens angle subtending at least a portion of said gaming table;
A second plurality of video cameras each of said second plurality of video cameras having a field of view showing the at least one of the local players at said gaming table;
Means for selecting one of said first or second plurality of video cameras in response to a detected state of play; and
A network manager for transferring a video stream generated by said selected video camera to at least one remote player.

27. The system of claim 26 wherein said selecting means further includes means for determining when to select a different camera to transmit video to said at least one remote player in response to a detected location of said gaming object.

28. The system of claim 27 further comprising:
A radio frequency detector circuit, carried by one of said local players; and
Means for determining the location of said one of said local players and associating said remote player with said one of said local players wherein said selecting means further includes means for determining when to select a different camera to transmit video to said at least one remote player in response to a detected location of said one of said local players.

29. The system of claim 28 wherein said local players consent to the transmission of their voice and image.

30. The system of claim 26 further comprising means for registering said remote player.
